(19) United States
(12) Patent Application Publication
(10) Pub. No.: US 2003/0125994 A1
(43) Pub. Date: Jul. 3, 2003

(54) Display for displaying data for a multiple travel related products and method for displaying same

(76) Inventors: Brad Jaehn, Chicago, IL (US); Brian P. Hopkins, Arlington Heights, IL (US)

Correspondence Address: Bell, Boyd & Lloyd LLC, P.O. Box 1135, Chicago, IL, 60690-1135, US

(21) Appl. No.: 10/295,177

(22) Filed: Nov. 15, 2002

Related U.S. Application Data
(63) Continuation-in-part of application No. 09/682,448, filed on Sep. 4, 2001.

(51) Int. Cl. G06F 17/60

(52) U.S. Cl. 705/5; 705/400

(57) ABSTRACT

An interactive display and display method for displaying hotel rates in an efficient easy to understand manner are provided. Further, an interactive display and method are provided for displaying pricing or other data of travel related products across multiple product lines. The results of customer initiated product/service search requests are displayed in a common matrix format, regardless of the selection parameters which are relevant to the particular product or service being searched. The common display format across multiple product lines provides a predictable, easy to use interface which enhances a customers experience and improves customer loyalty.

This application is a Continuation-In-Part application of U.S. patent application Ser. No. 09/682,448 filed on Sep. 4, 2001.

### BACKGROUND OF THE INVENTION

The present invention relates in general to an interactive interface for displaying data regarding a number of different travel related products, as well as a method for displaying such data. In particular, the interactive interface of the present invention enables customers to selectively view product displays for a number of different travel products. (In the context of the present specification “products” may encompass services as well as tangible goods). Each product display is constructed in a similar manner which allows customers to easily identify various product options and to compare the prices offered by various suppliers.

With the advent of the internet and the proliferation of travel related websites, more and more travelers are booking travel related services such as airline tickets, rental cars, and hotels on-line. An advantage of the internet is that it allows consumers to access vast amounts of data regarding the products and services offered by a wide range of providers. Today consumers can access travel websites and gather data on multiple travel service providers or consumers may contact individual service providers directly in hopes of getting the best rates possible.

The large amounts of data which are accessible over the internet raise issues as to how to display such data in a coherent and easily understood manner. What is more, it is often difficult to directly compare the offerings of one company against those of another. If a consumer visits a first supplier's website individually to view its product offerings and pricing, it is difficult to then compare the first supplier's product offerings and pricing to those of other suppliers. Take air fares for example. If a consumer accesses a first airline's website directly, he or she may search all of the fares offered by the first airline for flights between two specified cities. In order to compare fares of this first carrier with those of another carrier, the consumer must exit the first carrier's site, access a second carrier's site and re-execute substantially the same search on the second airline's website. In order to compare the results from the first search with those of the second search, the consumer must either page back and forth between the two results pages, or the consumer must print one of the results pages, or copy the fare data of interest by hand. A cumbersome process at best.

This problem is alleviated somewhat if the consumer visits a travel website having access to fares for multiple carriers. In this case the consumer may perform a single search and access fare data from a plurality of carriers for flights between his or her designated points of travel. However, the volume of data returned from such a search can be enormous. It is difficult to fit the results on a single screen to allow the customer to compare the fares offered by different carriers for similar flights. Many travel sites resort to a scrolling display to allow customers to scroll up or down through the search results to compare fares. However, this solution still suffers from the problem that all of the search results are not displayed at the same time, making direct comparisons difficult.

A solution to this last problem is provided by a matrix display 1 such as that shown in FIG. 1. According to display 1 a number of air carriers are listed across a horizontal axis of the display matrix, and the number of intermediate stops on flights between the two designated points of travel are displayed along the vertical axis 3. Fares offered by particular air carriers are listed in vertical columns 4 below icons representing the various carriers 5. Similarly, all non-stop direct fares are listed together along a first horizontal row 6, flights having a single intermediate stop are listed a second row 7, and so forth. Fares are listed in the corresponding rows and columns corresponding to the airline offering the fare, and whether the fare corresponds to a direct flight, one stop, two stop, and so forth. Thus, a large amount of fare data can be displayed in a single easy-to-read grid. Furthermore, detailed flight information 8 regarding the fares listed in the matrix may be listed in a more traditional scrolling manner below the matrix. Selecting one of the fares listed in the matrix, such as by mouse clicking on the desired fare, may cause details of the selected fare to be displayed at the top of the scrolling list.

In operating an internet business, it is desirable to present the customer with a consistent easy to use interface. By displaying product offerings for different product lines in a consistent manner and by requiring the customer to follow the same series of steps to display products and make purchases, the site becomes easier to use and the customer's experience is enhanced. A consistent product display method further improves brand identity and differentiates the online business from its competitors. A problem for online businesses, including on-line travel service providers, is that it is difficult to display different products with different selection criteria in a consistent and convenient way. A major stumbling block toward developing a uniform display for wide ranging product lines, especially in the travel services industry, is that the selection criteria—those attributes of one product which make it more attractive to a customer than another similar product—vary greatly from one product line to another. For example, some of the influencing factors for selecting an airline flight are the cost, the flight times, the origin and destination of the flight, the airline, and the number of stops en-route. Rental car selection, however, involves an entirely different set of criteria. Factors that may influence selection a rental car include the vehicle class (compact, mid-sized, full-sized, etc.), the rental car company, where the car is to be picked up and returned, and the price per day or per week, etc. Hotels rely on yet another distinct set of selection criteria. For example, hotels may be selected based on their location relative to a particular point of interest, the hotel rating (*, **, ***, etc.), the type of room desired (suite, beach front, smoking, etc.), and of course, the room rate. Presenting all of these different factors and options in a consistent, easy-to-use manner represents a significant challenge for web page designers who must design web interfaces geared toward selling multiple different travel related products from a single site.

### SUMMARY OF THE INVENTION

The present invention relates to an interactive display and method of displaying hotel rates in an efficient easy to understand manner. The invention further provides an interactive display and method for displaying pricing or other data for travel related products across multiple product lines. According to the invention the results of customer initiated product/service search requests are displayed in a common matrix format, regardless of the selection parameters which are relevant to the particular products or services being searched. The common display format across multiple product lines provides a predictable easy to use interface which enhances a customers experience and improve customer loyalty.

According to an embodiment of the invention, a display matrix for displaying hotel data is formed having a first axis and a second axis. The first axis represents a first selection parameter and the second axis represents a second selection parameter. A number of data entries are arranged in rows and columns along the first and second axes. Each row corresponds to a specific value of the first parameter and each column corresponds to a specific value of the second parameter. Furthermore, each data entry itself corresponds to a specific value of a third parameter. The first parameter may relate to the distance between various hotels and a designated point of interest, and the individual values of the first parameter may be displayed as distance ranges. The second parameter may relate to hotel ratings, with individual values corresponding one star (*), two star (**) and three star (***) ratings and the like. Finally, the data entries may correspond to room rates at hotels located a specified distance from the designated point of interest and having a particular rating, each corresponding to the row and column in which the entry is located.

Another embodiment of the invention provides a method of displaying hotel data. This method begins with the steps of designating a location near which a hotel is sought. The method next calls for defining a plurality of distance ranges and displaying the distance ranges along a first axis of a display matrix. The next step calls for identifying a hotel selection parameter (such as hotel rating, hotel chain name, or the like) and displaying discrete values of the hotel selection parameter along a second axis of the display matrix. Next, pricing data are displayed in rows and columns corresponding to the distance ranges and the discrete values of the hotel selection parameter such that each pricing data entry corresponds to a room rate at a specific hotel located within the corresponding distance range from the designated location, and which satisfies the requirements of the corresponding discrete value of the hotel selection parameter, i.e. having a specific rating or belonging to a particular hotel chain.

In another embodiment of the invention a method is provided for displaying pricing data for a number of disparate travel related products. This embodiment includes the steps of identifying first and second descriptive parameters for each product. Display matrices are constructed for each product such that in each matrix a plurality of data entries may be displayed in rows and columns. The data entries located in the same row correspond to products having a common value of the first parameter, and data entries located in the same column correspond to products having a common value of the second parameter. Pricing data are entered in at least some of the cells. The pricing data correspond to prices for the travel related products with which each matrix is associated, and for such products which meet product criteria established by the first and second parameter values of the row and column in which each cell is located. Finally, each matrix is selectably displayed to display said pricing data.

In yet another embodiment of the invention an interactive display is provided for displaying product data for a plurality of disparate travel related product lines on a computer monitor using a network browser. According to this embodiment of the invention the display includes a plurality of selectably displayable matrices. Each matrix corresponds to a different travel related product. Further, each matrix includes a first axis which represents a first set of discrete selection criteria and a second axis which represents a second set of discrete selection criteria. A plurality of entries are arranged in rows and columns, each row corresponding to entries which meet a specific selection criterion from among one of said first and second sets of discrete selection criteria, and each column corresponding to entries which meet a specific selection criterion of the other of said first and second sets of discrete selection criteria.

Additional features and advantages of the present invention are described in, and will be apparent from, the following Detailed Description of the Invention and the figures.

### BRIEF DESCRIPTION OF THE FIGURES

FIG. 1 is a display matrix for displaying air fare data.

FIG. 2 is a schematic representation of a rental car data display matrix according to the present invention displayed on a display device.

FIG. 3 is a display matrix according to the present invention displaying search results for a hypothetical rental car search.

FIG. 4 is a detailed information web page accessed by activating a hypertext link data element from the display matrix of FIG. 2.

FIG. 5 is a flow chart of a method for displaying rental car data according to the present invention.

FIG. 6 is a display matrix according to the present invention displaying search results for a hypothetical hotel search.

FIG. 7 is a flow chart showing a method for displaying product data for multiple product lines in a consistent easy to use manner according to the present invention.

### DETAILED DESCRIPTION OF THE INVENTION

The present invention relates to an interactive interface for displaying travel related product data for a number of disparate travel related product lines. Data are selectably displayed to customers based on customer defined criteria. The invention also relates to a method for displaying travel related product data for a number of different travel products in an efficient and easily understood manner. The interface organizes and displays search result data meeting customer's search criteria in individual matrices for each separate product line. The individual display matrices enable customers to efficiently compare product offerings from various suppliers in each of the various product lines in which the customer is interested. According to an embodiment of the invention, a customer may review additional details pertaining to each product offering and purchase the product or book reservations to use a service via the displays.

An embodiment of the invention includes a travel website which employs an airfare search results matrix as described in the background section. In addition to the airfare search results matrix, a similarly constructed car rental display matrix and a hotel display matrix are also employed. By displaying multiple product lines, each having widely different selection criteria, in uniform matrix based displays, a customer's experience using the travel website is improved. Search results may be quickly evaluated and products may be selected based on the displayed search results.

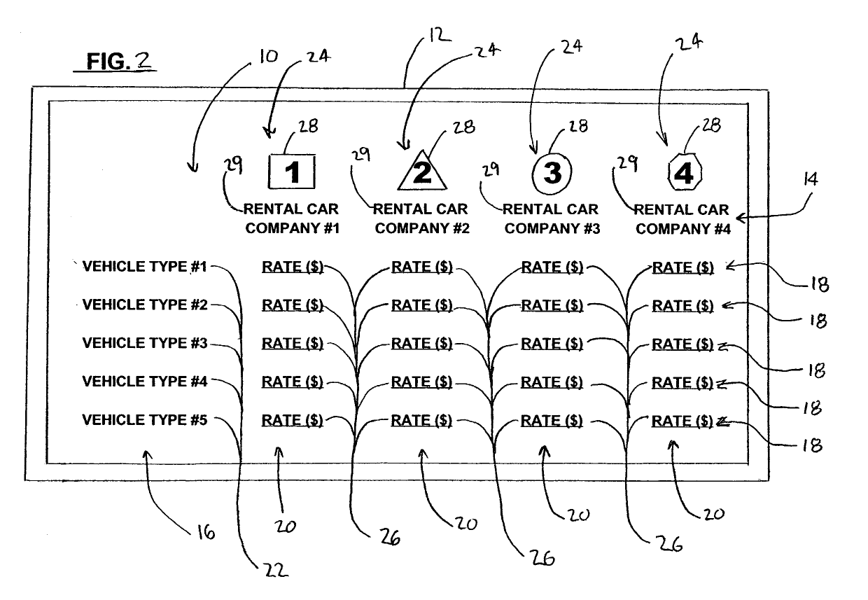

An embodiment of a rental car display matrix 10 according to the present invention is shown in FIG. 2. The rental car display matrix 10 is displayed on a monitor 12 of a personal computer. It should be noted, however, that the rental car data display matrix 10 may be displayed on any type of display device such as the LCD display of a handheld personal digital assistant, a video monitor, or other device. The rental car data display matrix 10 is defined by a horizontal axis 14, and a vertical axis 16. A plurality of data elements 26 are arranged within the matrix in horizontal rows 18 and vertical columns 20.

Each individual column of data is identified by a column heading 24, and each horizontal row is identified by a row heading 22. The number of rows and columns displayed in a display matrix 10 will depend on the search results obtained from the customer defined search criteria and the customers output device. Each row 18 represents a particular class of vehicle or vehicles with particular characteristics. Each column 20 represents the offerings of an individual rental car company. In an embodiment of the invention the column headings may be provided in the form of graphical icons 28 such as the trademarks or other brand identifiers of the various rental car companies whose rates are being displayed. Text 29, or other identifiers may also be used to identify the rental car companies represented by each column. The row headings will generally be brief text descriptions or icons representing the class of vehicles or special options available in vehicles represented by each row.

For example, if a search is performed for only a single class of vehicle, then only a single row of data having a single row heading describing the vehicle class searched will be displayed. On the other hand, if a search is performed for multiple classes of vehicles, then multiple rows with multiple row headings describing each vehicle class will be displayed. Likewise, if after performing a search it is determined that only a single rental car company has inventory and facilities available to meet the customer's requirements, then only a single column will be displayed. Conversely, if a number of rental car companies are available to meet the customer's requirements, then an equal number of columns will be displayed.

The data elements 18 displayed in the display matrix 10 represent the rates offered by the various rental car companies for the various classes of vehicles for which the corresponding search was performed. Preferably, the rate data displayed relate to the lowest prices available for specific types of cars or classes of vehicles offered by the various rental car companies. The rate data may be displayed on a per day basis, a per week basis, or on a total fee basis based on the dates and times for which the customer is requesting a vehicle, or some other basis. Generally, the format of the rate data will be determined by an availability search code of the host system. Regardless of the format chosen for displaying the fares, it is important that the rate displayed for each data element 18 is calculated in the same manner, i.e., returned by the same search and/or booking system and displayed on the same basis, so that a comparison of the different rates among different rental car companies and between different classes of vehicles will be meaningful.

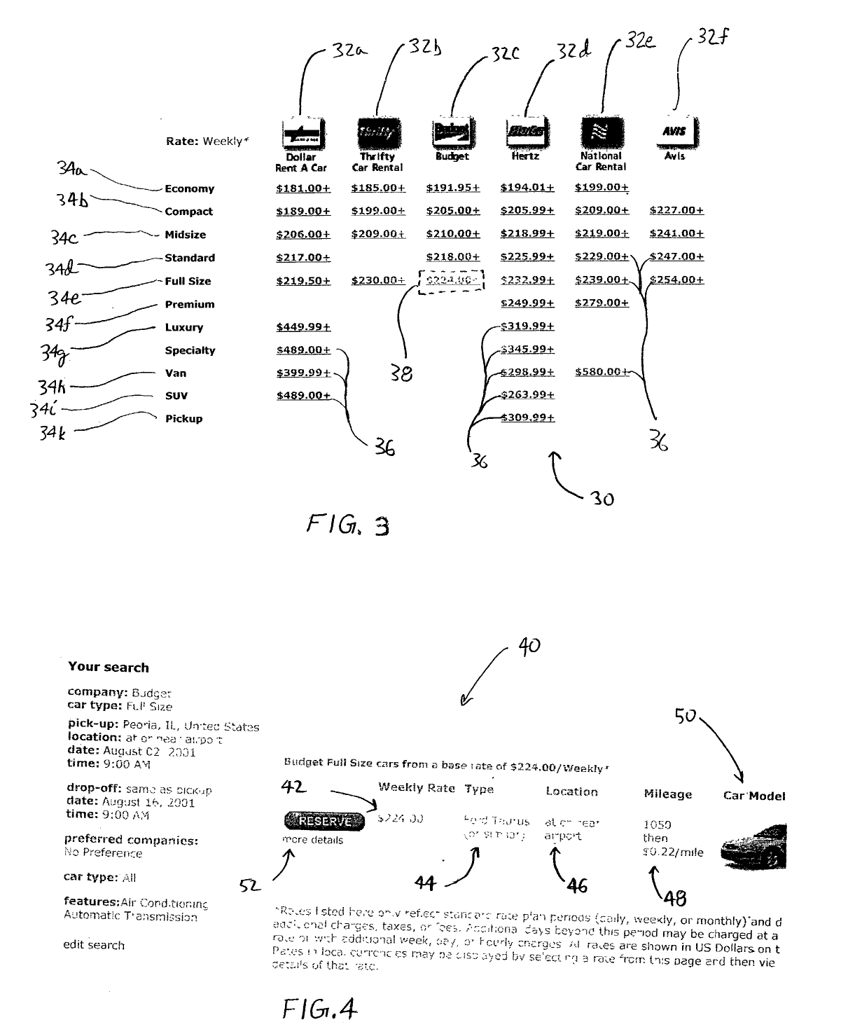

FIG. 3 shows a rental car display matrix 30 according to the present invention displaying the search results for a hypothetical customer search. The search criteria for the hypothetical search included a pickup and drop off location at or near the Peoria Airport. The car was to be picked up on August 2 at 9:00 A.M. and returned at 9:00 A.M., August 9. The search was to be conducted over all vehicle types having an automatic transmission and air conditioning. There were to be no preferences between rental car companies.

The display matrix 30 displaying the results includes column headings 32a, 32b, 32c, 32d, 32e, 32f along the top horizontal axis of the display. The column headings identify the rental car companies determined by the search to have facilities and vehicles available at or near the Peoria airport for the dates specified in the search. As can be seen, the column headings 32a-32f are a combination of a recognizable graphical icons identifying each rental car company, and the name of each rental car company written in plain text. Row headings 34a-34k are located along the left vertical axis. The row headings are merely one word textual descriptions of each vehicle class searched, although icons or other descriptors may also be provided. In the present example all vehicle types were searched and results were located for nine classes of vehicles, all of which are displayed. Of course, it is possible to classify vehicles differently than as shown. If a different classification scheme is selected, more or less rows may be required and the row headings may be changed.

As described earlier, data elements 36 are arranged in a matrix. The data elements 36 represent the rates the various rental car companies charge for the various vehicle classes. In the example shown, the rates are displayed in U.S. dollars, although other currencies may be displayed depending on the location where the car is to be picked up and dropped off, or the nationality of the customer performing the search. All of the rates offered by a given rental car company are arranged in columns, with the vertical position of a specific rate corresponding to the row associated with the class of vehicle for which the rate applies. Thus, the rates charged by each rental car company for a given class of vehicle are all found in the same row of the display matrix 30. Similarly, the rates charged by a specific rental car company for different classes of vehicles can all be found in the same column.

When viewing the data displayed in display matrix 30, it is a simple matter to quickly determine which rental car company offers the best price for each class of vehicle. All that is required is to locate the row associated with the desired class and scan horizontally across the row to find the lowest rate. Once the lowest rate has been found, scanning upward to the column heading at the top of the column in which the lowest rate appears identifies the rental car company offering the best rate for that particular class of vehicle. For example, to determine the best rate on a full sized car using display matrix 30, one must locate the full size row heading 34e and scan the data entries along that row. In this case, the entries are $219.50; $230.00; $224.00; $232.99; $239.00; and $254.00. Clearly, the $219.50 rate in the first column is the lowest. Looking to the top of the first column, column heading 32a identifies Company A as the company offering the $219.50 rate for a full size car. The same procedure may be employed to determine which company offers the best rate on a sport utility vehicle (SUV). After locating the SUV row 34j the customer determines there are only two data entries for SUVs. Thus, only two companies offer SUVs in Peoria, namely Company A and Company D, which are identified by the column headings 32a, 32d at the tops of the columns containing the two entries. The lower entry, that found in the fourth column, is associated with Company D. Where companies do not have offerings in a particular vehicle class, the corresponding row in the column is left blank. Alternatively, some other indication may be provided, such as displaying “not available” or some other message in the corresponding row/column position.

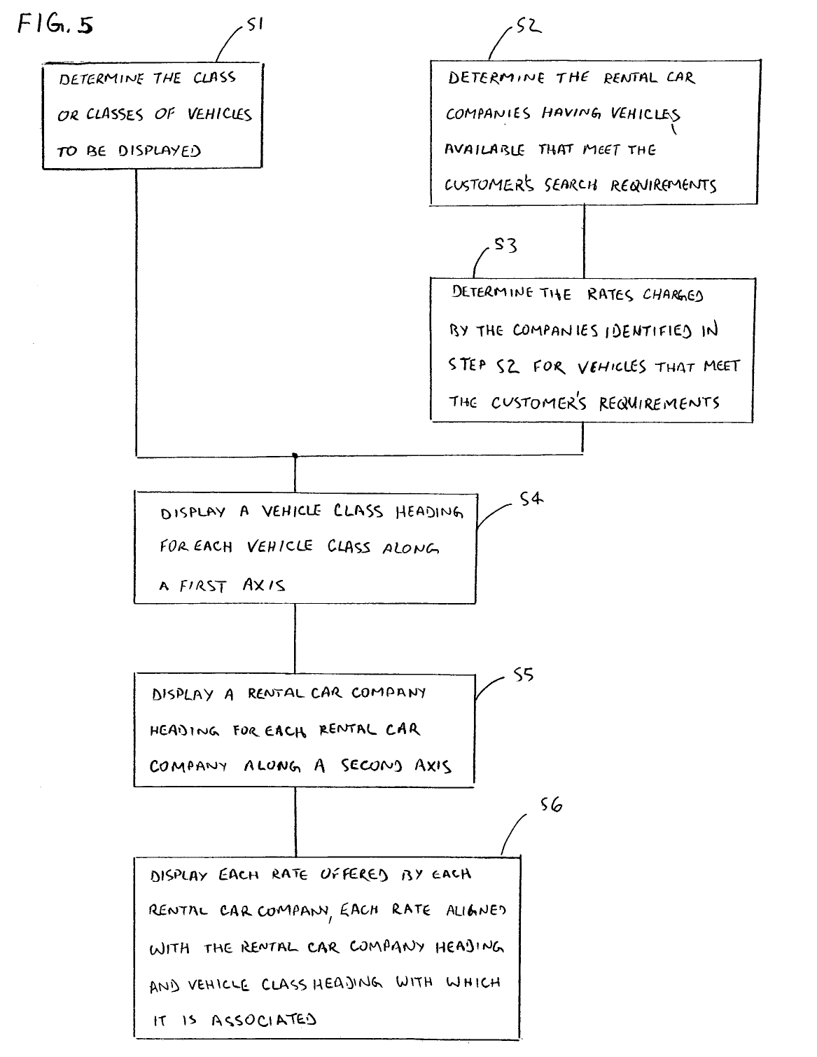

In an embodiment of the invention, the data elements 36, namely the rates listed in the various rows and columns of the display matrix are created as hypertext links to other internet web pages which provide additional detailed information regarding the rental packages represented by the data elements displayed in the display matrix. An example of a detailed information page that is displayed after selecting the hypertext link associated with data element 38 is shown in FIG. 4. The detailed information page 40 includes the rate 42, the type of car 44, the pickup/return location 46, allowed mileage and charge for over mileage 48, and a picture of the car 50. Of course other data could be displayed if desired. The detailed information page further includes a hypertext link 52 to an additional information page, and a hypertext link 54 to a reservation page for booking a reservation.

The present invention further encompasses a method for displaying rental car availability and rate data. A flow chart detailing the method is shown in FIG. 5. Steps S1-S2 and steps S3-S5 of the inventive method may be carried out substantially simultaneously or they may be carried out sequentially. In step S1, the class or classes of vehicles for which data are to be displayed are identified. In step S2, a heading is displayed for each class of vehicle identified in step S1. The vehicle class headings are displayed along a first axis. In step S3, rental car companies having vehicles available meeting a customer's search requirements are identified. Then, in step S4 the rates offered by the rental car companies identified in step S3 are identified for the various classes of vehicles identified. In step S5, headings identifying the rental car companies identified in step S3 are displayed along a second axis. Finally, in step S6, the rate data are displayed in matrix form. Individual data elements are aligned with the various vehicle class headings and rental car company headings with which they are associated. Thus, a rental car display matrix is created from which the lowest rates available for different classes of vehicles can be easily determined, as can the identity of the rental car company offering the lowest rates for the various classes of vehicles.

When the method of the present invention is practiced on an internet web browser for displaying rental car rate data on a computer screen, the step of displaying each available rate may include displaying the rate as a hypertext link to another web page. The web page addressed by the rate data hypertext link may be a page for giving additional details on the rental package offered by the rental car company or the addressed page may be a reservation page where the customer secures a reservation for the selected class of vehicle at the displayed rate.

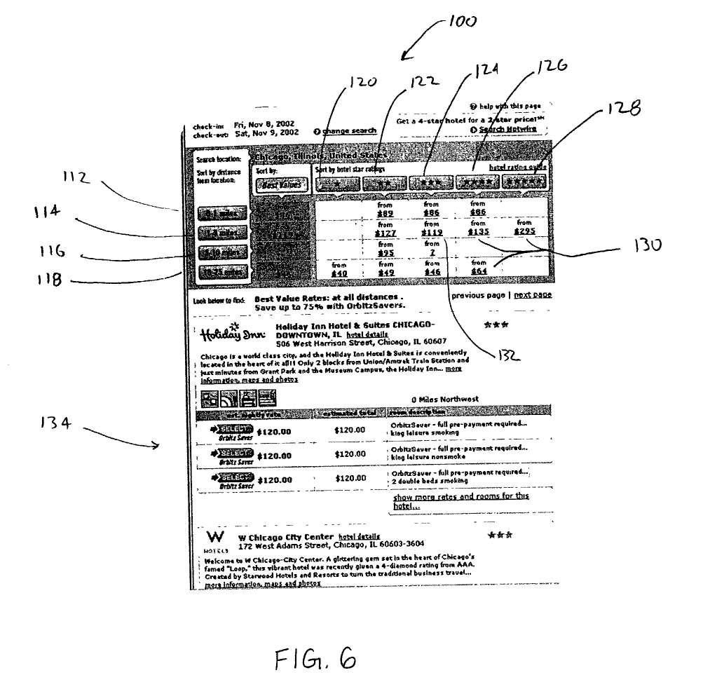

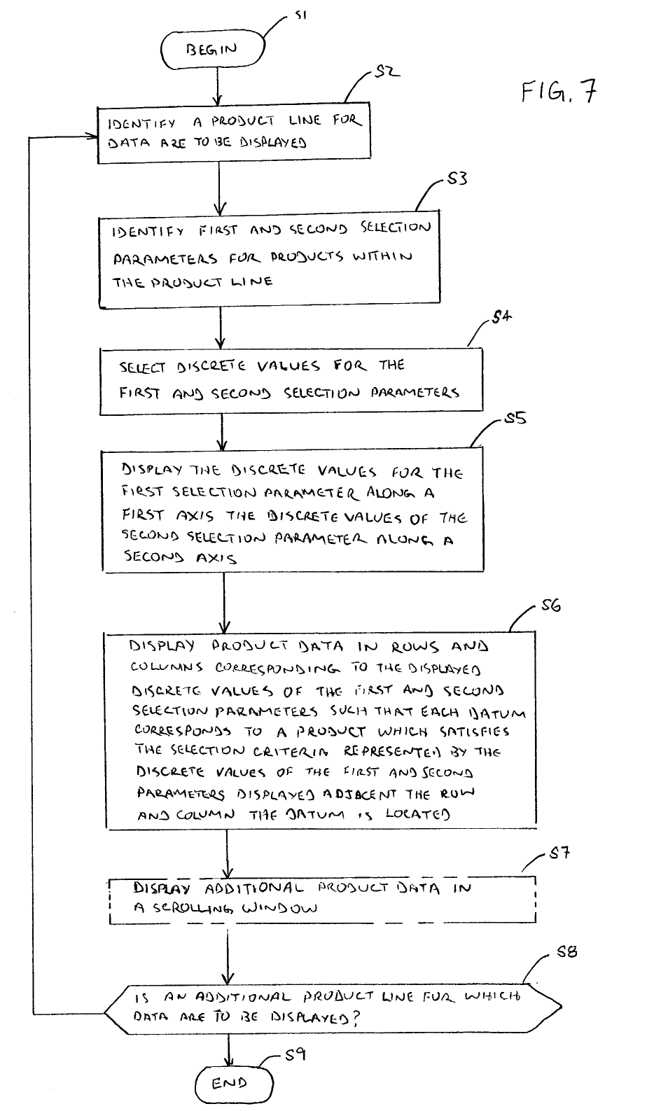

Turning to FIG. 6, an embodiment of a hotel display matrix 100 is shown. In this configuration the selection parameter defined by the vertical axis is the distance between a hotel and a particular point of interest defined by the customer. Each row of the display matrix corresponds to discrete values of this parameter. Thus, the row headings 112, 114, 116 and 118 of the hotel matrix 100 displayed in FIG. 6 indicate that the first row 112 relates to hotels in the range 0-1 mile away from the designated point of interest. The second row 114 relates to hotels 1-5 miles from the designated point of interest. Hotels 5-10 miles from the designated location are listed in the third row, and hotels 10-25 miles away are listed in the fourth row.

According to the embodiment of FIG. 6, the selection parameter represented by the horizontal axis is the hotel rating. Travel services often rate hotels according to a 1-5 star (*−*****) scale, with one star (*) hotels receiving the least desirable hotels and five star hotels (*****) receiving the most desirable. In the present embodiment of the invention each column 120-128 in the display matrix 100 represents hotels which have received a common rating. Column 120 represents one-star hotels, column 122 represents two-star hotels, and so forth. Column 128 represents the most luxurious five-star hotels.

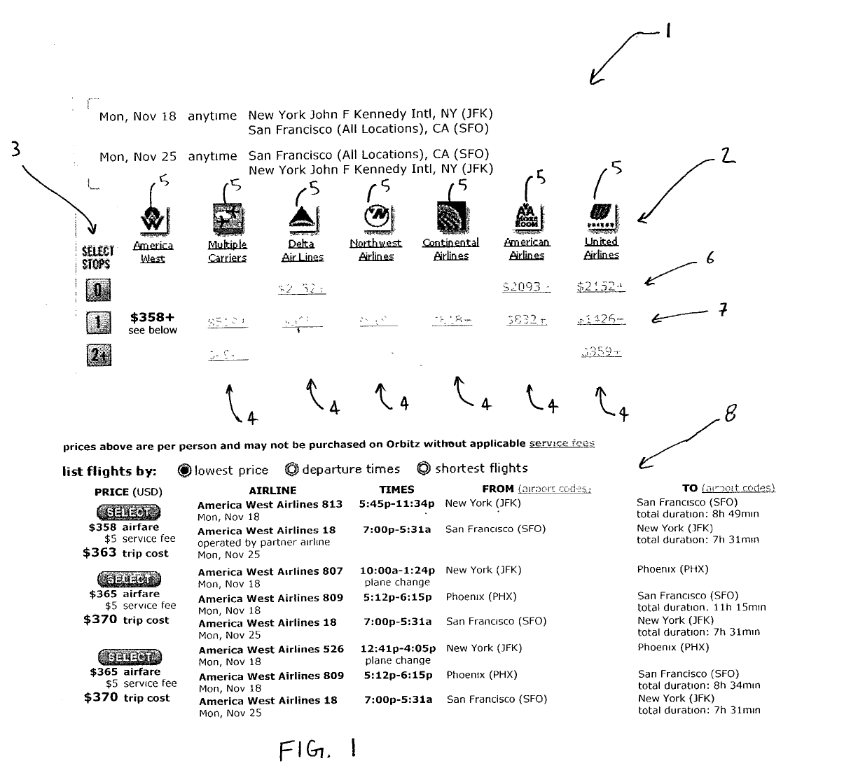

In an alternative embodiment the horizontal axis may represent a different selection parameter. For example, in lieu of hotel ratings, hotel data can be displayed based on hotel chains in the same way that rental car data is displayed according to the rental car company in the rental car display matrix of FIG. 2 and the air fare data are displayed in the airfare display matrix of FIG. 1.

Regardless of which selection parameters are represented by the vertical and horizontal axes of the display matrix 100, each row of the matrix corresponds to a specific value or range of values of a first selection parameter and each column corresponds to a specific value of a second selection parameter. Data elements 130 are written in the various data cells defined by the intersecting rows and columns of the matrix. Each data element corresponds to the respective parameter values of the row and column of the cell in which it is located. Thus, in the display matrix 100 of FIG. 6 the data elements 130 represent room rates at various hotels which meet the specific values of the selection parameters represented by the vertical and horizontal axis, namely in this case the distance from a desired location and the hotel rating. For example, cell 132 located in the second row 114 and column 124 represents a three star hotel located between one and five miles from a specified location. As indicated from the data displayed in the cell 132, rooms at this hotel start from $119 per night.

Additional information 134 regarding each data element entered in the matrix 100 may be displayed in a traditional scroll type window below the matrix or elsewhere on the display screen. The display can be configured such that by selecting a particular data element by, for example mouse clicking the desired data element, the corresponding additional information is placed at the top of the scroll window. Furthermore, reservations may be booked at one of the listed hotels by selecting a link from the desired hotel listing to additional hotel booking processes.

It should be clear that the matrix 100 displays a large amount of data in a clear easy to digest format. A customer reviewing the contents of the display matrix can quickly ascertain the best hotel option that meets his or her requirements and budget.

By employing a combination of the air fare display matrix shown in FIG. 1, the car rental display matrix of FIG. 2, and the hotel matrix shown in FIG. 6, as well as possibly other similarly constructed travel product/services display matrices for other travel related products and services as a single integrated interface, an online travel website can provide its customers with a consistent interactive display interface across multiple product lines. This makes the site easier to use and enhances the customer's experience with the site. The consistent display format also serves to establish brand recognition and develop customer loyalty.

Thus, the present invention also includes a method for displaying product data for multiple product lines in a consistent easy to use manner. A flow chart of the inventive method is shown in FIG. 7. The process begins at step S1. At step S2 a first product line is identified for which data are to be displayed regarding different product offerings from various suppliers. In an embodiment of the invention the product line may be selected from among airline tickets, rental cars and hotels.

Once the product line for which a display is being created has been identified, first and second selection parameters are selected as illustrated in step S3. The first and second selection parameters describe and differentiate various product offerings within the product line for which product data are being displayed. In the case of an air fare display matrix, for example, the first and second selection parameters may be air carriers and the number of scheduled stops on flights from a first designated city to a second designated city. Similarly, first and second selection parameters may include car rental companies and class of vehicle, if rental car data are being displayed. In the case of a hotel data matrix, the first and second selection parameters may include the distance between a hotel and a specified location and the hotel rating, respectively. Of course, other selection parameters may be selected if desired.

At step S4 of the inventive method discrete values of the first and second selection parameters are selected. It should be noted that the term “values” is not being used in a numeric sense (although some parameter values such as distance from a particular point of interest or number of stops of a given flight may be expressed numerically). For purposes of the present discussion parameter values will refer to any discrete characteristic the parameter may take on. For example, in an air fare display matrix, one of the selection parameters may be identified as “Air Carriers”. Individual values that this parameter may take on include “United”, “American”, “Continental”, “Northwest”, and the like. Also, distance from specified location may include values—0-1 mile, 1-5 miles and so forth. Of course, the discrete parameters which are selected in step 4 will correspond to the products whose data are being compiled displayed in the matrix.

At step S6 the selection parameter values selected in step 4 are displayed along first and second axes of the display matrix being constructed. The product data are displayed in rows and columns defined by the displayed values of the first and second selection parameters. The data are arranged such that each entry corresponds to a product characterized by the first and second parameter values at the head of the column and row in which the product entry is located. Step S7, shown in phantom, is optional to the present display method. Step S7 calls for displaying additional details about the product entries displayed in the matrix in a traditional scrolling type display window. Each data element in the matrix may be linked to its corresponding detailed entry such that selecting a particular data entry will cause the corresponding detailed entry to be displayed at the top of the scrolling window display.

Finally, at step S8, a determination is made as to whether a display matrix for another product line must be displayed. If yes, the process returns to step S2 and is repeated to create an additional display matrix for the next product line. However, if no other product line is offered the process ends at step S9.

The method outlined above provides a mechanism by which a number of different displays may be created, with each display being tailored to display the important features and options of unrelated product lines. However, because each display is created according to a common format, a customer can quickly become familiar with and analyze the data in each display, despite the fact that each product line is based on radically different selection criteria. By astute selection of the selection parameters represented by each axis of the matrices, an on-line travel service provider or other internet retailer, may present the salient features of multiple products across an entire range of product lines in a concise easy to digest manner. What is more, all product lines will be displayed in a similar, recognizable pattern that will enhance brand recognition and boost customer loyalty to the site.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A display matrix for displaying hotel data comprising:
a first axis representing a first parameter;
a second axis representing a second parameter;
a plurality of data entries arranged in rows and columns along said first axis and said second axis with each row corresponding to a specific value of said first parameter and each column corresponding to a specific value of said second parameter, each data entry corresponding to a specific value of a third parameter.

2. The display matrix of claim 1 wherein said first parameter is a distance between a hotel and a specified location and each row corresponds to a specified range of distances.

3. The display matrix of claim 1 wherein said second parameter is a distance between a hotel and a specified location and each column corresponds to a range of distances.

4. The display matrix of claim 1 wherein said first parameter is a hotel rating system and each row corresponds to a specific hotel rating designation.

5. The display matrix of claim 1 wherein said second parameter is a hotel rating system and each column corresponds to a specific hotel rating designation.

6. The display matrix of claim 1 wherein said first parameter corresponds to hotel chains and each row corresponds to specific hotel chain.

7. The display matrix of claim 1 wherein second parameter corresponds to hotel chains and each column corresponds to a specific hotel chain.

8. The display matrix of claim 1 wherein said third parameter corresponds to a room rate at a specific hotel satisfying the parameter values of the row and column in which the corresponding data entry is located.

9. The display matrix of claim 1 wherein additional information regarding a specific hotel and room rate may be displayed by selecting the corresponding data entry.

10. A method for displaying pricing data for a plurality of disparate travel related products, the method comprising the steps of:
identifying first and second descriptive parameters for each product;
constructing a display matrix for each product wherein, in each matrix, a plurality of data entries may be displayed in rows and column such that data entries located in the same row correspond to products having a common value of the first parameter, and data entries located in the same column correspond to products having a common value of the second parameter;
entering pricing data in at least some of the cells, of each matrix wherein the pricing data correspond to prices for the travel related products with which each matrix is associated, and for such products which meet product criteria established by said first and second parameter values of the row and column in which each cell is located; and
selectively displaying each matrix to display said pricing data.

11. The method of claim 10 wherein said travel related products include airline tickets, rental cars and hotel rooms.

12. The method of claim 10 further comprising the steps of:
receiving input from a user indicating a desire to view additional data regarding a travel related product whose pricing data are displayed in a cell; and
displaying corresponding additional pricing data.

13. The method of claim 10 wherein one of said travel related products comprises airline tickets.

14. The method of claim 13 wherein one of said first and second parameters associated with airline tickets comprises the number of stops on scheduled flights between designated locations.

15. The method of claim 13 wherein one of said first and second parameters associated with airline tickets comprises air carriers offering flights between designated locations.

16. The method of claim 10 wherein one of said travel related products comprises rental cars.

17. The method of claim 16 wherein one of said first and second parameters associated with rental cars comprises vehicle class.

18. The method of claim 16 wherein one of said first and second parameters associated with rental cars comprises rental car companies.

19. The method of claim 10 wherein one of said travel related products comprises hotel rooms.

20. The method of claim 19 wherein one of said first and second parameters associated with hotels comprises a distance between a hotel and a designated location.

21. The method of claim 19 wherein one of said first and second parameters associated with hotels comprises a hotel rating.

22. The method of claim 19 wherein one of said first and second parameters associated with hotels comprises hotel chains.

23. An interactive display for displaying product data for a plurality of disparate travel related product lines on a computer monitor using a network browser, the display comprising:
a plurality of selectably displayable matrices, each matrix corresponding to a different travel related product;
each matrix including a first axis representing a first set of discrete selection criteria and a second axis representing a second set of discrete selection criteria; and
a plurality of entries arranged in rows and columns, each row corresponding to entries which meet a specific selection criterion from among one of said first and second sets of discrete selection criteria, and each column corresponding to entries which meet a specific selection criterion of the other of said first and second sets of discrete selection criteria.

24. The method of claim 23 wherein said travel related products include airline tickets, rental cars and hotel rooms.

25. The method of claim 23 further comprising the steps of:
receiving input from a user indicating a desire to view additional data regarding a travel related product whose pricing data are displayed in a cell; and
displaying corresponding additional pricing data.

26. The method of claim 23 wherein one of said travel related products comprises airline tickets.

27. The method of claim 26 wherein one of said first and second parameters associated with airline tickets comprises the number of stops on scheduled flights between designated locations.

28. The method of claim 26 wherein one of said first and second parameters associated with airline tickets comprises air carriers offering flights between designated locations.

29. The method of claim 23 wherein one of said travel related products comprises rental cars.

30. The method of claim 29 wherein one of said first and second parameters associated with rental cars comprises vehicle class.

31. The method of claim 29 wherein one of said first and second parameters associated with rental cars comprises rental car companies.

32. The method of claim 23 wherein one of said travel related products comprises hotel rooms.

33. The method of claim 32 wherein one of said first and second parameters associated with hotels comprises a distance between a hotel and a designated location.

34. The method of claim 32 wherein one of said first and second parameters associated with hotels comprises a hotel rating.

35. The method of claim 32 wherein one of said first and second parameters associated with hotels comprises hotel chains.

36. A method of displaying hotel data comprising the steps of:
designating a location;
defining a plurality of distance ranges and displaying said distance ranges along a first axis;
identifying a hotel selection parameter and displaying discrete values of said hotel selection parameter along a second axis;
displaying pricing data in rows and columns corresponding to said distance ranges and said discrete values of said hotel selection parameters such that each pricing data entry corresponds to a room rate at a hotel located within the corresponding distance range from the designated location, and which meets the corresponding discrete value of the hotel selection parameter.

37. The method of claim 36 wherein said hotel selection parameter comprises a hotel rating system.

38. The method of claim 36 wherein said hotel selection parameter comprise hotel companies.

39. The method of claim 36 further comprising the step of linking each pricing data entry to additional date regarding the corresponding hotel.
